(19) United States
(12) Patent Application Publication
(10) Pub. No.: US 2020/0309455 A1
(43) Pub. Date: Oct. 1, 2020

(54) DOOR OPENER AND SUBSTRATE PROCESSING APPARATUS PROVIDED THEREWITH

(71) Applicant: ASM IP Holding B.V., Almere (NL)

(72) Inventor: Jeroen Fluit, Amsterdam (NL)

(21) Appl. No.: 16/827,012

(22) Filed: Mar. 23, 2020

Related U.S. Application Data
(60) Provisional application No. 62/825,273, filed on Mar. 28, 2019.

(51) Int. Cl. F27D 3/00; E06B 7/22; E05F 1/00; F27D 3/12

(52) U.S. Cl. CPC F27D 3/0084; F27D 3/12; E05F 1/00; E06B 7/22

(57) ABSTRACT

The disclosure relates to a door opener to open a door of a cassette with substrates, the opener having a first wall to engage with the cassette and having a first opening to transfer the door and the substrates and a second wall opposite the first wall and having a second opening to transfer substrates. The door opener may have a closure device to hold the door of the cassette and having first and second sides and moveable in a chamber formed between the first and second wall. The opener may have a first actuator to move the closure device in a first direction from a first closing position where the first side closes against the first wall to a second closing position where the second side closes against the second wall, and from the second closing position to a transport position in between the first and second closing positions.

### CROSS-REFERENCE TO RELATED APPLICATIONS

This application claims priority to U.S. Provisional Patent Application Ser. No. 62/825,273 filed Mar. 28, 2019 titled DOOR OPENER AND SUBSTRATE PROCESSING APPARATUS PROVIDED THEREWITH, the disclosure of which is hereby incorporated by reference in its entirety.

### FIELD

The present disclosure generally relates to a door opener constructed and arranged to open a door of a cassette with substrates. More particularly, the disclosure relates to a door opener comprising: a first wall configured to engage with the cassette and provided with a first opening to transfer the door and substrates of the cassette; and, a second wall opposite the first wall and provided with a second opening to transfer substrates. A closure device may be configured to hold the door of the cassette and moveable in a chamber formed between the first and second wall. The door opener may be provided to a substrate processing apparatus.

### BACKGROUND

For transporting substrates, use may be made of cassettes provided with a door fitted such that it is removable. Said door can be provided to a greater or lesser extent with a gastight seal with respect to the other part of the cassette. If the substrates have to be treated in a substrate processing apparatus such as a furnace, the substrates may be removed from the cassette and placed in a substrate rack and said substrate rack may then be introduced, together with the substrates, into a reactor. After treatment the substrates together with the rack may be removed from the reactor and the substrates may be transferred back to the cassette and transported for further treatment.

Substrate processing apparatus, such as furnaces, may be functioning in a controlled atmosphere, for example, an inert nitrogen atmosphere. It may be advantageous to bring the substrates into such a controlled atmosphere before said substrates enter a space in which the reactor has been arranged to prevent dilution of the controlled atmosphere in the space.

A construction having a lock chamber to bring the substrates into a controlled atmosphere may be described in U.S. Pat. No. 6,481,945. The construction may be provided with two separate closures in a lock chamber formed between the first and second wall. It thereby becomes possible to close off both the first and the second opening in the first and second wall individually with the separate closures. The design with the two separate closures requiring separate actuators in the lock chamber may be quit complex to manufacture and maintain. Accordingly, it may be an objective to provide a simplified door opener which may be easier to manufacture and maintain.

### SUMMARY OF THE INVENTION

This summary is provided to introduce a selection of concepts in a simplified form. These concepts are described in further detail in the detailed description of example embodiments of the disclosure below. This summary is not intended to identify key features or essential features of the claimed subject matter, nor is it intended to be used to limit the scope of the claimed subject matter.

According to an objective, it may be desirable to provide in an embodiment, a door opener constructed and arranged to open a door of a cassette with substrates. The opener may comprise a first wall configured to engage with the cassette and provided with a first opening to transfer the door and substrates of the cassette. The opener may be provided with a second wall opposite the first wall and provided with a second opening to transfer substrates.

A closure device may be configured to hold the door of the cassette. The closure device may be moveable in a chamber formed between the first and second wall. The opener may be provided with a first actuator constructed and arranged to move the closure device with the door in a first direction from a first closing position where a first side of the closing device substantially closes against the first wall to a second closing position where the second side of the closing device substantially closes against the second wall. The first actuator may be constructed and arranged to move the closure device from the second closing position to a transport position in between the first and second closing positions. The embodiment of the door opener may be made appreciably more compact and simple, which makes it easier to construct and maintain the door opener.

According to an embodiment, there may be provided a substrate processing apparatus provided with the door opener, the apparatus further comprising a substrate handling robot provided in a substrate handling room. The first and second wall of the door opener may form a wall of the substrate handling room. The apparatus may comprise a nitrogen purge system constructed and arranged to provide a purge flow in the substrate handling room.

According to a further embodiment, there may be provided a method of opening a door of a cassette with substrates. The method may comprise:

moving the cassette with substrates against a first wall provided with a first opening;

grabbing the door of the cassette with a closing device provided with first and second sides;

moving the closure device with the door of the cassette in a first direction from a first closing position where the first side substantially closes against the first wall to a second closing position where the second side substantially closes against a second wall opposite the first wall;

moving the closure device with the door of the cassette in the first direction from the second closing position to a transport position in between the first and second closing positions;

and,

moving the closure device with the door of the cassette in a second direction substantially perpendicular to the first direction from the transport position to a storage position in a chamber between the first and second wall.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught or suggested herein without necessarily achieving other objects or advantages as may be taught or suggested herein.

All of these embodiments are intended to be within the scope of the invention herein disclosed. These and other embodiments will become readily apparent to those skilled in the art from the following detailed description of certain embodiments having reference to the attached figures, the invention not being limited to any particular embodiment(s) disclosed.

### BRIEF DESCRIPTION OF THE FIGURES

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

FIG. 1 shows a schematic top view of an example of the substrate processing apparatus according to an embodiment;

FIGS. 2a to 2f show a schematic top view of a door opener for use in the apparatus of FIG. 1 during opening a cassette in various positions according to an embodiment; and,

FIG. 3 shows a schematic top view of a door opener for use in the apparatus of FIG. 1 in more detail according to an embodiment.

### DETAILED DESCRIPTION OF THE FIGURES

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below. The illustrations presented herein are not meant to be actual views of any particular material, structure, or device, but are merely idealized representations that are used to describe embodiments of the disclosure.

As used herein, the term “substrate” or “wafer” may refer to any underlying material or materials that may be used, or upon which, a device, a circuit, or a film may be formed. The term “semiconductor device structure” may refer to any portion of a processed, or partially processed, semiconductor structure that is, includes, or defines at least a portion of an active or passive component of a semiconductor device to be formed on or in a semiconductor substrate. For example, semiconductor device structures may include, active and passive components of integrated circuits, such as, for example, transistors, memory elements, transducers, capacitors, resistors, conductive lines, conductive vias, and conductive contact pads.

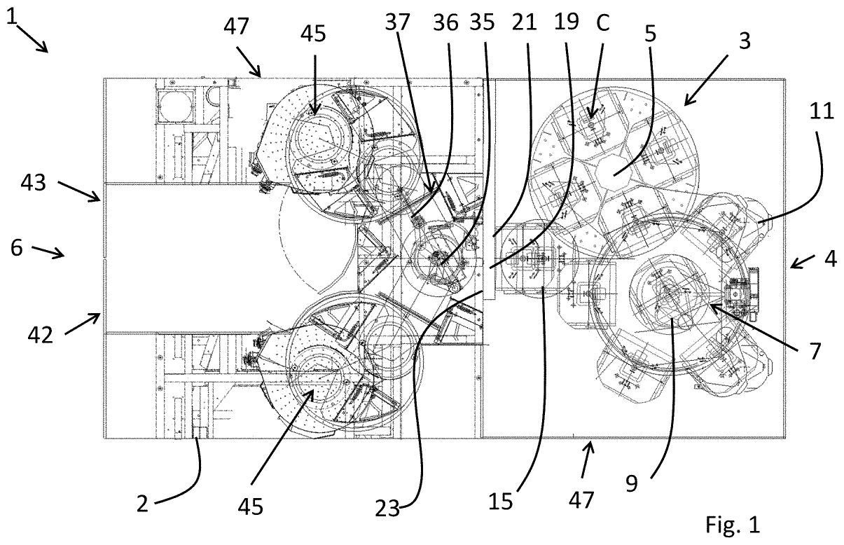

FIG. 1 shows a schematic top view of an example of the substrate processing apparatus, e.g., furnace 1, according to an embodiment. The furnace 1 comprises a housing 2 with a front wall 4 and a back wall 6. The furnace 1 may comprise a storage device such as a cassette storage carousel 3 for storing a plurality of substrate cassettes C which substrate cassettes each accommodate a plurality of substrates. The cassette storage carousel 3 may comprise a number of platform stages for supporting cassettes. The platform stages may be connected to a central support which is mounted rotatable around a vertical axis 5. Each platform stage is configured for accommodating a number of cassettes C. A drive assembly is operatively connected to the central support for rotating the central support with the number of platform stages around the vertical axis 5.

The furnace 1 may have a cassette handler 7 having a cassette handler arm 9 configured to transfer cassettes C between the cassette storage carousel 3, a cassette in-out port 11 adjacent the front wall 4 of the housing 2 of the furnace 1, and/or a substrate transfer position 15. The cassette handler 7 may comprise an elevating mechanism to reach to the cassettes at different height. Each platform stage for storing cassettes may have a cut-out therein the cut-out sized and shaped to allow the cassette handler arm 9 to pass vertically there through and to allow the platform stage to support a cassette C thereon.

A door opener 19 constructed and arranged to open a door of a cassette C with substrates may be provided. The opener 19 may comprise a first wall 21 configured to engage with the cassette C and provided with a first opening to transfer the door and substrates of the cassette. The opener 19 may have a second wall opposite the first wall and provided with a second opening to transfer substrates to the substrate handling robot 35. The first and or second wall may be part of an internal wall separating the cassette handler 7 and the substrate handling robot 35. The substrate transfer position 15 may be provided with a cassette mover to turn the cassette C and/or to move the cassette C against the door opener 19.

The substrate processing apparatus may comprise a substrate handling robot 35 provided with a substrate handling arm 36 to transfer substrates from a cassette C positioned on the substrate transfer position 15 through the door opener 19 to a substrate rack and vice versa. The furnace may comprise a substrate handling room 37 in which the substrate handling robot 35 is accommodated.

The housing 2 may have a first and second side wall 47 extending over the full length of the furnace 1. The distance between the sidewalls 47 of the furnace which may define the width of the apparatus may be between 190 and 250 cm, preferably between 210 and 230 cm and most preferably around 220 cm. Maintenance of the furnace 1 may be performed from the backside 6 or front side 4 of the furnace so that there may be no need for doors in the side walls 47.

With the construction of the sidewalls 47 without doors multiple furnaces 1 may be positioned side by side in a semiconductor fabrication plant. The sidewalls of adjacent furnaces may thereby be positioned very close to, or even against, each other. Advantageously, the multiple furnaces may form a wall with the front side 4 of the furnaces 1 interfacing with a cassette transport device in a very clean environment of a so called “clean room” having very strict requirements for particles. The back side 6 of the furnace 1 may interface with a maintenance alley, which may have less strict requirements for particles than the front side 4.

The furnace 1 may be provided with a first reactor and a second reactors 45 for processing a plurality of substrates. Using two reactors may improve the productivity of the furnace 1. The substrate processing apparatus in top view may be configured in a substantial U-shape. A maintenance area 43 may be constructed and arranged between the legs of the U-shape. The distance between the two legs of the U-shape may be between 60 and 120 cm, more preferably between 80 and 100 cm and most preferably around 90 cm to allow enough space for a maintenance worker. A back door 42 may be provided between the legs of the U-shape to close off the maintenance area 43 when not in use.

The first and second reactors 45 may be constructed and arranged in the legs of the U-shape. The first and second reactors 45 may be provided in the lower part of the legs of the U-shape. The substantial U-shape may include a V-shape as well.

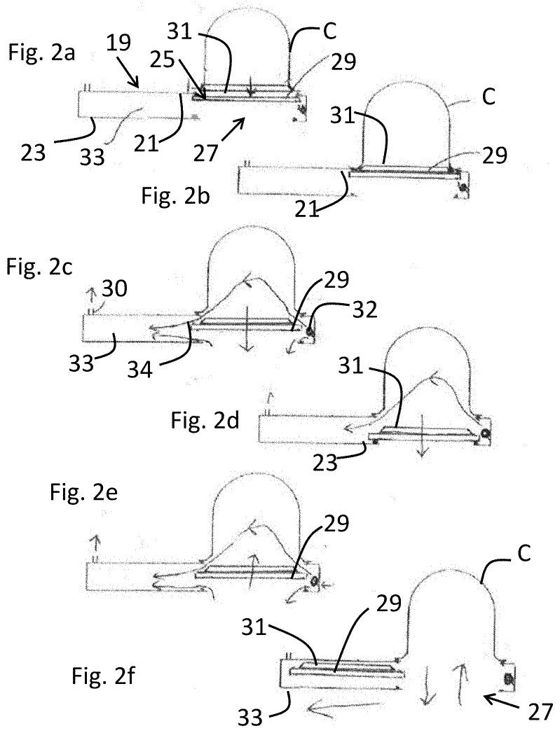

FIGS. 2a to 2f show a schematic top view of a door opener 19 for use in the apparatus of FIG. 1 during various positions of opening a cassette C. The door opener 19 may comprise a first wall 21 configured to engage with the cassette C and provided with a first opening 25 to transfer the door and substrates of the cassette C. The door opener 19 may have a second wall 23 opposite the first wall 21 and provided with a second opening 27 to transfer substrates to the substrate handling robot. The first opening 25 may be opposite to the second opening 27. The first and second openings 25, 27 may be aligned with each other. The first and/or second wall 21, 23 may be part of an internal wall separating the cassette handler and the substrate handling robot. The door opener 19 may have a closure device 29 configured to hold the door 31 of the cassette and moveable in a chamber 33 formed between the first and second wall 21, 23.

In FIG. 2a, it is shown that the cassette C may be moved towards the door opener 19 with the cassette mover at the substrate transfer position 15 (see FIG. 1) so that the cassette C may be placed against the first wall 21 and the door 31 of the cassette C may be pressed against the closure device 29. The closure device 29 may be provided with first and second sides. The sides may be opposite each other on the closure device. The closing device may be a rigid structure with the first and second side rigidly connected. The first side may be configured to engage with the door 31 of the cassette C. Said first side may for this purpose be provided with a gripper or lock to engage with the door 31 and to grab it. The gripper or lock may upon engagement with the door 31 also release the door from the cassette C.

A flexible seal, e.g., a rubber seal, may be provided to the first wall 21 to seal against the cassette C. Optionally, a flexible seal, e.g., a rubber seal, may be also be provided to the first surface of the closure device 29 to seal against the door 31 of the cassette C.

In FIGS. 2b, 2c and 2d, it may be shown how the closure device 29 while holding the door 31 of the cassette C may be moved in a first direction from a first closing position to a second closing position. In the first closing position the first side may close against the first wall 21 (FIG. 2b). In the second closing position the second side may close against the second wall 23 (FIG. 2d). The door opener 19 may be provided with a first actuator to move the closure device 29 in the first direction. A flexible seal, e.g., a rubber seal, may be provided to the second wall 23 or the second side of the closure device 29 to seal the gap between the second wall and the second side.

The door opener 19 may comprise a gas feed 32 to provide a gas flow into the chamber 33. The door opener may comprise a gas discharge 30 to discharge gas from the chamber 33. During and/or after opening cassette C, gas may be blown into the cassette C and the chamber 31 from gas feed 32. This may be accomplished over the entire height of the cassette C between all substrates arranged in the cassette. The gas flow indicated by the arrows 34 in FIG. 2c may be produced towards the gas discharge 30. A purging flow of gas through the entire cassette 10 may be created which creates a nitrogen atmosphere there. This nitrogen atmosphere may be created before opening the second opening 27 fully to reduce dilution of the atmosphere in the substrate handling room.

To open the second opening fully, the closure device 29 may first be moved from the second closing position to a transport position in between the first and second closing positions (see FIG. 2e). This movement may be accomplished in the first direction. In the transport position, there is enough clearance from the first and second wall 21, 23 to move the closure device 19 with the door 31 of the cassette C attached thereto to a storage position in the chamber 33. For example, by moving it in the second direction (see FIG. 2f) substantially perpendicular to the first direction with a second actuator. When the door 31 and the closure device 29 are moved away from the second opening 27, the substrates may be exchanged from the cassette C with the substrate handling robot 35 (see FIG. 1) in the substrate handling room 37.

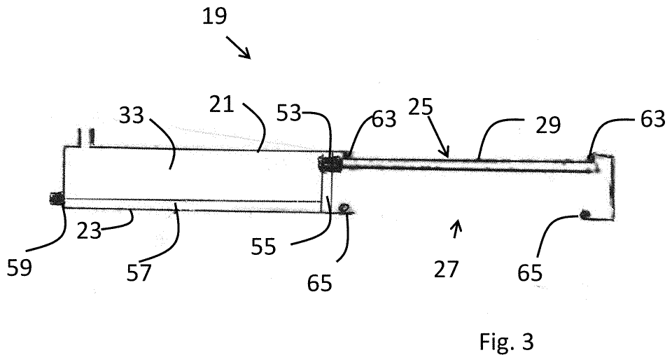

FIG. 3 shows a schematic top view of a door opener 19 for use in the apparatus of FIG. 1 with the actuators in more detail. The door opener 19 may be connected to a first actuator 53 constructed and arranged to move the closure device 29 in a first direction. The first actuator 53 may be moveable along the guide 55 from a first closing position where the first side of the closure device 29 closes against the first wall 21 to a second closing position where the second side closes against the second wall 23.

A flexible seal 63, e.g., a rubber seal, may be provided to the first side of the closure device 29 to seal against the first wall 21. Alternatively, the flexible seal may be provided to the first wall 21 to seal against the first side of the closure device 29. Another flexible seal 65 may be provided to the second wall 23 to seal against the second side of the closure device 29. The other flexible seal may also be provided to the second side of the closure device 29 to seal against the second wall 21.

The first actuator 53 may be used to move the closure device 29 along the guide 55 in the first direction from the second closing position to a transport position in between the first and second closing positions. In the transport position there is enough clearance from the first and second wall 21, 23 to move the closure device 19 (even with a door of the cassette attached thereto) with the second actuator 59 in the second direction substantially perpendicular to the first direction to a storage position in the chamber 33. The second actuator 59 may be connected to a spindle 57 to move the guide 55 with the first actuator 53 and the closing device 29 in the second direction.

The particular implementations shown and described are illustrative of the invention and its best mode and are not intended to otherwise limit the scope of the aspects and implementations in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationship or physical connections may be present in the practical system, and/or may be absent in some embodiments.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. Thus, the various acts illustrated may be performed in the sequence illustrated, in other sequences, or omitted in some cases.

The subject matter of the present disclosure includes all novel and nonobvious combinations and sub combinations of the various processes, systems, and configurations, and other features, functions, acts, and/or properties disclosed herein, as well as any and all equivalents thereof.

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below. The illustrations presented herein are not meant to be actual views of any particular material, structure, or device, but are merely idealized representations that are used to describe embodiments of the disclosure.

1. A door opener constructed and arranged to open a door of a cassette with substrates, the opener comprising:
a first wall configured to engage with the cassette and provided with a first opening to transfer the door and substrates of the cassette;
a second wall opposite the first wall and provided with a second opening to transfer substrates; and,
a closure device configured to hold the door of the cassette and moveable in a chamber formed between the first and second wall, wherein the opener is provided with a first actuator constructed and arranged to move the closure device with the door in a first direction:
from a first closing position where a first side of the closing device substantially closes against the first wall to a second closing position where the second side of the closing device substantially closes against the second wall; and,
from the second closing position to a transport position in between the first and second closing positions.

2. The door opener according to claim 1, wherein the first and second openings are directly opposite to each other.

3. The door opener according to claim 1, wherein the first and second openings are aligned with each other.

4. The door opener according to claim 1, wherein the first and second side are opposite the closing device.

5. The door opener according to claim 1, wherein the closing device is a rigid structure with the first and second side rigidly connected.

6. The door opener according to claim 1, wherein the door opener is constructed and arranged with space between the first and second wall to move the closure device with the door of the cassette held thereby in between the first and second wall in a second direction substantially perpendicular to the first direction.

7. The door opener according to claim 1, wherein the opener comprises a second actuator constructed and arranged to move the closure device from the transport position to a storage position in the chamber.

8. The door opener according to claim 7, wherein the second actuator moves the closure device through the chamber in a second direction substantially perpendicular to the first direction.

9. The door opener according to claim 1, wherein the opener comprises a gas feed constructed and arranged to provide a gas in the chamber.

10. The door opener according to claim 1, wherein the opener comprises a gas discharge constructed and arranged to discharge gas from the chamber.

11. The door opener according to claim 1, wherein said opener comprises a gas feed constructed and arranged to provide a stream of gas into said cassette.

12. The door opener according to claim 1, wherein a flexible seal is provided to one or more of the first wall, second wall, a first surface and a second surface.

13. A substrate processing apparatus provided with the door opener according to claim 1, the apparatus further comprising a substrate handling robot provided in a substrate handling room and the first and second wall of the door opener form a wall of the substrate handling room, wherein the apparatus comprises a nitrogen purge system constructed and arranged to provide a purge flow in the substrate handling room.

14. A method of opening a door of a cassette with substrates, the method comprising:
moving the cassette with substrates against a first wall provided with a first opening;
grabbing the door of the cassette with a closing device provided with first and second sides;
moving the closure device with the door of the cassette in a first direction from a first closing position where the first side substantially closes against the first wall to a second closing position where the second side substantially closes against a second wall opposite the first wall;
moving the closure device with the door of the cassette in the first direction from the second closing position to a transport position in between the first and second closing positions; and
moving the closure device with the door of the cassette in a second direction substantially perpendicular to the first direction from the transport position to a storage position in a chamber between the first and second wall.

15. The method according to claim 14, wherein the method comprises providing a gas in the chamber with a gas feed.

16. The method according to claim 14, wherein the method comprises discharging gas from the chamber with a gas discharge.
